(19) United States
(12) Patent Application Publication
(10) Pub. No.: US 2022/0344842 A1
(43) Pub. Date: Oct. 27, 2022

(54) Connection unit having actuating elements and conductor connection openings which are arranged in two rows

(71) Applicant: PHOENIX CONTACT GmbH & Co. KG, Blomberg (DE)

(72) Inventor: Peter WERMTER, Blomberg (DE)

(21) Appl. No.: 17/765,691

(22) PCT Filed: Oct. 2, 2020
(86) PCT No.: PCT/EP2020/077715

§ 371 Date: Mar. 31, 2022

(30) Foreign Application Priority Data
Oct. 2, 2019 (DE) 10 2019 126 662.9

(51) Int. Cl. H01R 4/48; H01R 12/51

(52) U.S. Cl. CPC H01R 4/4836; H01R 12/515

(57) ABSTRACT

A connection unit includes a plurality of connection elements arranged next to one another. Each connection element has a conductor connection opening for accommodating an electrical conductor and an actuating element for clamping the electrical conductor in the conductor connection opening and/or releasing said conductor. The actuating elements and the conductor connection openings are arranged on a common side of the connection unit. The actuating elements and the conductor connection openings of the connection elements are arranged in two rows which are spaced apart from one another. The connection unit has at least one first connection element of which the actuating element is arranged in a first row and the conductor connection opening is arranged in a second row, and at least one second connection element of which the actuating element is arranged in the second row and of which the conductor connection opening is arranged in the first row.

This patent application claims the priority of German patent application 10 2019 126 662.9, the disclosure of which is hereby expressly referred to.

The present invention relates to a connection unit comprising a plurality of connection elements arranged next to one another, each connection element having a conductor connection opening for accommodating an electrical conductor and an actuating element for clamping the electrical conductor in the conductor connection opening and/or releasing said conductor, the actuating elements and the conductor connection openings being arranged on a common side of the connection unit and the actuating elements and the conductor connection openings of the connection elements being arranged in two rows which are spaced apart from one another.

The present invention also relates to a connection block comprising a housing and a plurality of connection elements which are accommodated in the housing, the plurality of connection elements being arranged next to one another in the housing, each connection element having a conductor connection opening for accommodating an electrical conductor and an actuating element for clamping the electrical conductor in the conductor connection opening and/or releasing said conductor, the actuating elements and the conductor connection openings being arranged on a common side of the housing of the connection block and the actuating elements and the conductor connection openings of the connection elements being arranged in two rows which are spaced apart from one another.

Corresponding connection units and connection blocks are known from the prior art to connect a plurality of electrical conductors in an efficient manner. The arrangement of the actuating elements and the conductor connection openings on one side of the connection unit is common in order to make easy handling possible. The arrangement of the actuating elements and the conductor connection openings in the two rows also allows the connection units to be provided with small dimensions. A required expansion of the connection unit on the side of the actuating elements and the conductor connection openings can be kept limited to the extension of the actuating elements and the conductor connection openings.

In this case, the connection elements can be designed, for example, as spring-loaded clamps and arranged in a common housing. In the case of spring-loaded clamps, the clamping of the electrical conductors in the relevant conductor connection opening is automatically brought about by means of the insertion of the electrical conductors and can be released by means of an actuation via the associated actuating element. The connection units and connection blocks can also be designed for mounting on a printed circuit board, with pins extending through the printed circuit board and being soldered thereto, for example.

A minimum distance between the connection elements depends on a minimum distance between their conductor connection openings. The minimum distance results, for example, from the size of the conductor connection opening and a maximum permissible voltage. The result is what is known as a grid dimension, which defines an arrangement of the conductor connection openings and thus of the connection elements next to one another. The grid dimension indicates in each case a distance from a point of a connection element to the same point of an adjacent connection element. If the connection elements are arranged directly next to one another, the grid dimension corresponds to the width of the connection elements.

The electrical conductors have a conductive wire or strand and a surrounding insulation. The conductor connection openings accommodate the conductive wire or strand, leaving the insulation exposed. When using electrical conductors having wire ferrules, in particular having plastics collars, it may even arise that due to the expansion of the wire ferrules, in particular of a diameter of the plastics collar thereof, conductor connection openings of adjacent connection elements cannot be used at the same time. Alternatively, the use of wire ferrules can be ruled out in order to be able to use the conductor connection openings of the adjacent connection elements at the same time. In order to use the electrical conductors that also have wire ferrules, it is therefore necessary to increase the grid dimension for the known connection units.

Proceeding from this, the problem addressed by the present invention is that of providing a connection unit of the type mentioned at the outset, which unit has the most compact dimensions possible and is particularly suitable for the use of electrical conductors having wire ferrules.

The problem addressed by the present invention is solved by a connection unit having the features of claim 1. Advantageous embodiments of the connection unit are described in claims 2 to 12, which are dependent on claim 1.

More precisely, the problem addressed by the present invention is solved by a connection unit having a plurality of connection elements which are arranged next to one another, each connection element having a conductor connection opening for accommodating an electrical conductor and an actuating element for clamping the electrical conductor in the conductor connection opening and/or releasing said conductor, the actuating elements and the conductor connection openings being arranged on a common side of the connection unit, the actuating elements and the conductor connection openings of the connection elements being arranged in two rows which are spaced apart from one another, and the connection unit having at least one first connection element of which the actuating element is arranged in a first row and of which the conductor connection opening is arranged in a second row, and having at least one second connection element of which the actuating element is arranged in the second row and of which the conductor connection opening is arranged in the first row.

The problem addressed by the present invention is also solved by a connection block having the features of claim 13.

Thus, the problem addressed by the present invention is also solved more precisely by a connection block having a housing and a plurality of connection elements which are accommodated in the housing, the plurality of connection elements being arranged next to one another in the housing, each connection element having a conductor connection opening for accommodating an electrical conductor and an actuating element for clamping the electrical conductor in the conductor connection opening and/or releasing said conductor, the actuating elements and the conductor connection openings being arranged on a common side of the housing of the connection block, the actuating elements and the conductor connection openings of the connection elements being arranged in two rows which are spaced apart from one another, and the connection block having at least one first connection element of which the actuating element is arranged in a first row and of which the conductor connection opening is arranged in a second row, and having at least one second connection element of which the actuating element is arranged in the second row and of which the conductor connection opening is arranged in the first row.

The connection unit according to the invention has the advantage that by arranging the first and second connection elements together, the distances between conductor connection openings of adjacent first and second connection elements can be increased, and so the conductor connection openings can be used efficiently to connect the electrical conductors. If a conductor connection opening and an actuating element are arranged adjacent to one another in a row, there is no need for two electrical conductors to be inserted directly adjacently to one another into conductor connection openings. In contrast, the distances between adjacent conductor connection openings in the prior art result as a distance from one connection element to the next. According to the invention, the electrical conductors can thus be reliably positioned in the conductor connection openings without, for example, impeding one another due to their insulation. In particular when using wire ferrules or the like, there are sufficiently large distances between the conductor connection openings of adjacent connection elements in order to also allow electrical conductors having wire ferrules to be inserted. It is not necessary to increase the distances between the conductor connection openings. On the contrary, it is even possible to design the individual connection elements to be particularly narrow in order to provide a particularly compact connection unit or a particularly compact connection block. It is not necessary, for example, to dispense with the use of electrical conductors having wire ferrules. It is thus also possible to use conductor cross sections which cannot be used when only first or second connection elements are used. Overall, this results in easy handling for inserting or removing an electrical conductor, which improves the handling of the actuating elements and conductor connection openings. This embodiment and the following embodiments apply to both the connection unit and the connection block.

The embodiment according to the invention of the connection unit and the connection block also allows easy handling, because in the case of adjacent first and second connection elements, there is free space around an electrical conductor inserted into a conductor connection opening due to the actuating element of the other connection element, and so the electrical conductor can always be easily gripped. The actuation of the connection elements via the actuating elements is ensured since the actuating elements only have to be accessed when required in order to clamp and/or unclamp the electrical conductors. Access can therefore be given as required, leaving sufficient space between two electrical conductors, even between electrical conductors having wire ferrules.

The electrical conductors can each lead an electric potential. In this case, the electrical conductors can comprise a single conducting wire or a plurality of conducting wires which are twisted together, for example. In addition, the electrical conductors comprise a surrounding insulation. The conductor connection openings typically only accommodate the conducting wire or wires.

The result is an arrangement of the first and second connection elements in columns next to one another, with the actuating element and the conductor connection opening of a connection element each forming a column. The actuating element and the conductor connection opening lie on an axis of the connection element. The result is a matrix-like arrangement of the actuating elements and the conductor connection openings in the two rows and on the connection elements. The actuating element and the conductor connection opening of each connection element are preferably at the same distance from one another in order to create a simple arrangement of the actuating elements and conductor connection openings in the two rows.

The connection element comprises exactly the two rows in which the actuating elements and the conductor connection openings are arranged. The actuating element and the conductor connection opening of each connection element are arranged in the first and second rows, respectively.

In an advantageous embodiment, the connection unit has a plurality of first and second connection elements, and the first and second connection elements are arranged at least partially alternately adjacent to one another. An arrangement, at least in portions, with alternating first and second connection elements is formed. At least in this portion, the distances between adjacent conductor connection openings in each of the rows result as a distance between identical first or second connection elements along the row, i.e. the distance corresponds to the distance between two connection elements. This maximizes the distances between the conductor connection openings. The result is a regular arrangement of conductor connection openings and actuating elements in each of the two rows, at least in this portion.

In an advantageous embodiment, the first and second connection elements are identical, with the second connection elements being arranged in the connection unit in a manner rotated by 180° with respect to the first connection elements. The same applies to the connection block. The first and second connection elements are therefore still parallelly arranged; more precisely, the connection elements are antiparallelly arranged to form the first and second connection elements. Correspondingly, the actuating elements and the associated conductor connection elements of each connection element are each at the same distance from one another. This means that the actuating elements and the conductor connection elements can be arranged in a straight line in the two rows. The connection unit can be formed easily and inexpensively by using identical connection elements.

In an advantageous embodiment, the connection elements are arranged with a grid dimension which is smaller than a collar diameter of a wire ferrule of a maximum usable connection cross section of the conductor connection opening. The grid dimension defines a distance of an arrangement of the individual connection elements next to one another. It indicates the distance from a point of a connection element to the same point of an adjacent connection element. If the connection elements are arranged next to one another without gaps, the grid dimension corresponds to a width of the connection elements. A compact connection unit is formed by arranging the connection elements next to one another without gaps. Depending on the cable cross section, there are permissible dimensions of wire ferrules, in particular the collar diameter thereof, which are permissible when taking into account safety aspects, and smaller than in the prior art.

In an advantageous embodiment, the connection elements are designed in such a way that the grid dimension divided by a maximum collar diameter has a value of approximately 0.875. This means, for example, that a connection unit for a maximum cross section of 4 mm² and a collar diameter of 5.4 mm results in a grid dimension of 4.8 mm rounded up (5.4×0.875=4.725). The collar diameter refers to a wire ferrule for use with the electrical conductor having the appropriate cross section. In the prior art, on the other hand, a grid dimension corresponding to the collar diameter would be required, i.e. 5.4 mm. In this example, the grid dimension is reduced by about 0.6 mm compared to the prior art.

In an advantageous embodiment, the connection elements are arranged with a grid dimension that is smaller than an outer diameter of an insulation of an electrical conductor of a maximum usable connection cross section of the conductor connection openings. The adjacent arrangement of the first and second connection elements results in a distance between the conductor connection openings of each row that corresponds to twice the grid dimension. In principle, the connection elements can thus be designed so narrowly that the insulation of the electrical conductors already protrudes beyond a relevant connection element.

In an advantageous embodiment, the connection unit has a common housing in which the plurality of connection elements are arranged. A compact connection unit is provided which allows the connection elements to be attached together. The connection elements are preferably arranged integrally in the housing and connected thereto to form a clamping block. The clamping block is provided as an inseparable unit.

In an advantageous embodiment, the common housing is designed as a housing for printed circuit board mounting. The connection unit can be used in the manner of printed circuit board clamps or a printed circuit board connector for printed circuit board mounting. In this case, the connection unit preferably comprises pins which are inserted into the printed circuit board or passed through the circuit board in order to mount the connection unit thereon.

The pins are particularly preferably designed as contact pins which bring about electrical contacting of the conductor connection openings with the printed circuit board. The connection unit can be fastened to the printed circuit board, for example, by clamping. Alternatively or additionally, the pins are designed as soldering pins in order to fasten the connection unit to the printed circuit board by soldering. In an alternative embodiment, the housing can be designed for circuit board mounting in such a way that it is plugged onto a pin strip of the printed circuit board so that plug-in mounting takes place. The pin strip comprises a plurality of pins which are preferably designed as contact pins for electrical contacting.

In an advantageous embodiment, the connection elements are designed as spring-loaded clamps having a clamping spring, which keeps electrical conductors clamped in the conductor connection openings with the spring force thereof, and the actuating elements are designed to release the clamping of the electrical conductors by means of the clamping spring upon actuation. In the case of the spring-loaded clamps, the clamping of the electrical conductors in the relevant conductor connection opening is therefore already brought about by means of the insertion of the conductors and can be released by means of an actuation via the associated actuating element. The spring-loaded clamps allow the electrical conductors to be easily and reliably accommodated and contacted in the conductor connection openings. The clamping can also be released easily via the relevant actuating element. In this case, the clamping spring is tensioned by actuating the actuating element such that the electrical conductor inserted into the conductor connection opening is released and can be removed therefrom.

In an advantageous embodiment, the actuating elements are designed as actuating pushbuttons. The actuating pushbuttons allow the clamping to be released when said pushbuttons are pressed in the direction of the relevant connection element, which can be carried out easily. In this case, the actuating pushbutton typically acts directly against the clamping spring in order to tension the clamping spring and unclamp the electrical conductor accommodated in the conductor connection opening. The restoring force of the clamping spring resets the actuating pushbutton after actuation. In addition, an electrical conductor accommodated in the conductor connection opening is clamped and contacted therein after actuation. Actuating pushbuttons of this kind are also known as pushers.

In alternative embodiments, the connection elements can be designed with different actuating elements. These actuating elements include, for example, pulling or lifting elements or an actuating element that is designed with an eyelet, whereby the actuating element can only be actuated by means of a special tool and is therefore protected against unwanted actuation.

In an advantageous embodiment, the connection elements are designed as screw clamps, with the actuating elements being designed as actuating screws, and the electrical conductors being both clamped in the conductor connection openings and released by the actuating screws. Screw clamps allow the electrical conductors to be reliably accommodated and fastened in the conductor connection openings. The actuating screws can be used to clamp the electrical conductor in the respective conductor connection openings and release said conductor in a controlled manner. Depending on the design of the screw clamps, deflection elements can be provided, which implement a screwing in of the actuating screws in order to clamp electrical conductors introduced parallel to the actuating screws in the conductor connection openings or to unclamp them. For example, the rotational movement of the actuating screws can be deflected to clamping screws by an angle of 90°.

In an advantageous embodiment, the connection unit has first and/or second connection elements comprising conductor connection openings for accommodating electrical conductors having different maximum cross sections. In this case, any of the first and/or second connection elements comprising conductor connection openings can be designed and combined for accommodating electrical conductors having any maximum cross sections. In this case, the arrangement of the conductor connection openings in the first or second row is based on a corresponding arrangement, for example on a center point of the conductor connection openings.

In an exemplary embodiment, the connection unit comprises four, eight or sixteen parallelly arranged connection elements. However, the invention is not limited to a specific number of parallelly arranged connection elements.

Further advantages, details, and features of the invention can be found in the following in the described embodiments. The drawings show, in detail, the following:

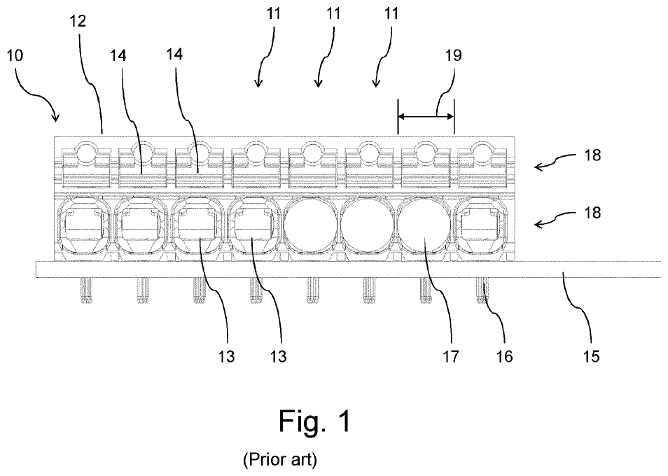

FIG. 1: a representation of a connection unit from the prior art with eight parallelly arranged connection elements in a front view;

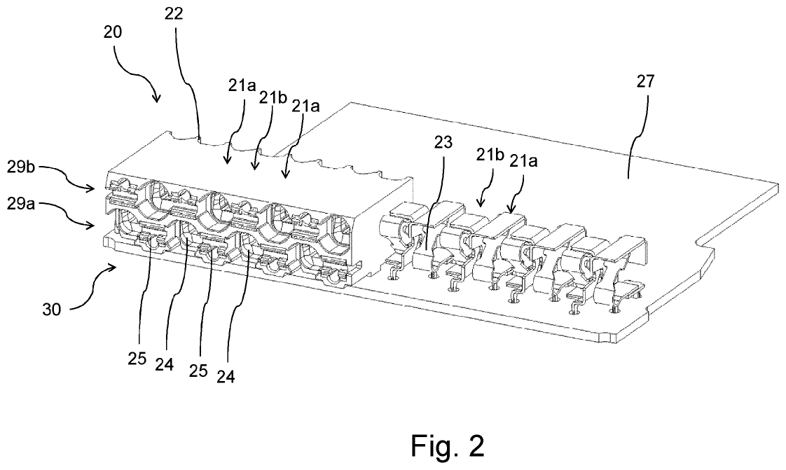

FIG. 2: a representation of a connection unit of a first, preferred embodiment with sixteen parallelly arranged connection elements in a perspective view in a mounted state on a printed circuit board, the connection elements being designed with an actuating pushbutton and some of the connection elements being shown without a housing;

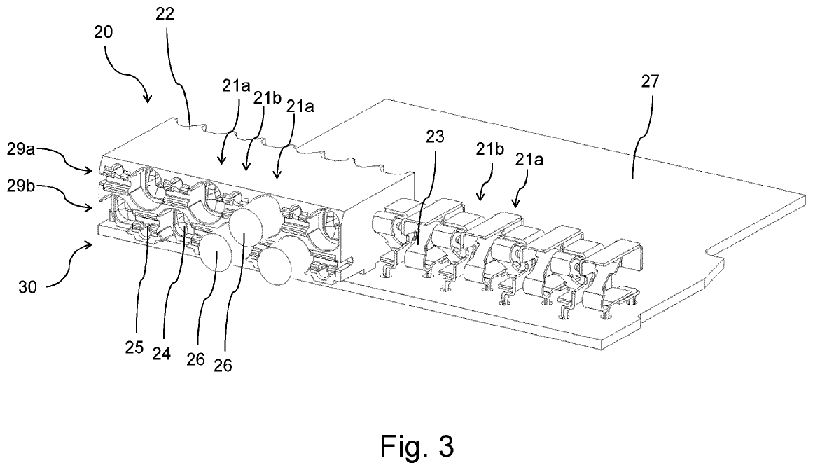

FIG. 3: a representation of the connection unit from FIG. 2, with additional electrical conductors being inserted into some conductor connection openings;

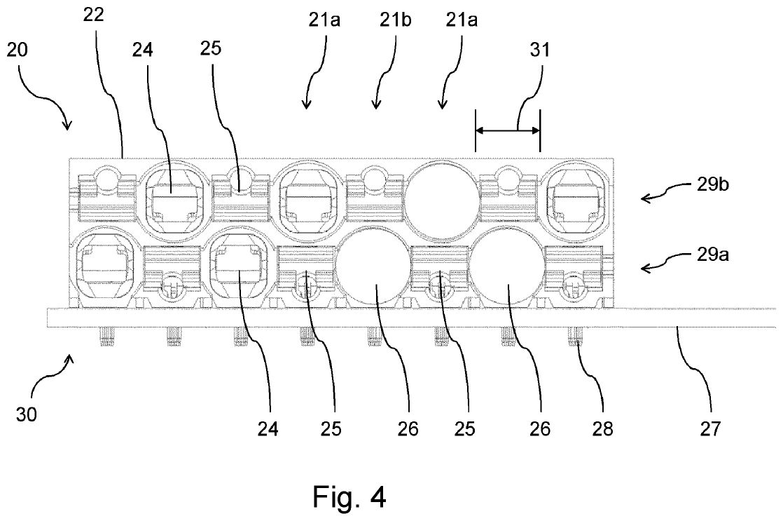

FIG. 4: a partial representation of the connection unit from FIG. 3 in a front view; and

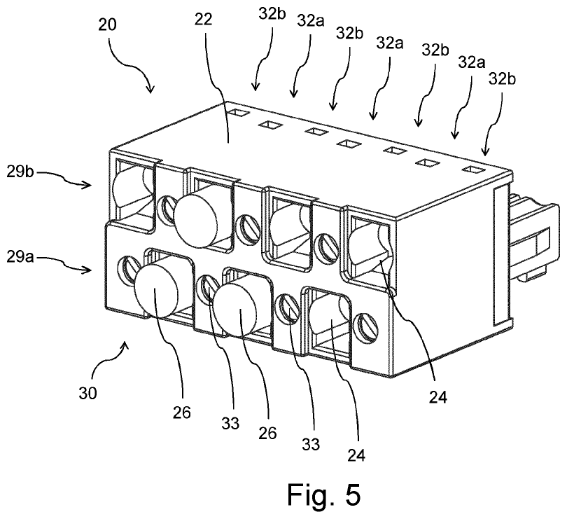

FIG. 5: a representation of a connection unit of a second embodiment with seven parallelly arranged connection elements in a perspective view, the connection elements being designed as screw clamps with an actuating screw.

In the following description, the same reference signs denote the same components or features, so that a description of a component with reference to one drawing also applies to the other drawings, thus avoiding repetitive description. Furthermore, individual features which have been described in connection with one embodiment can also be used separately in other embodiments.

A connection unit 10 from the prior art is shown in FIG. 1. The connection unit 10 comprises a plurality of parallelly arranged connection elements 11, which are designed as spring-loaded clamps and are arranged in a common housing 12. Each of the connection elements 11 comprises a conductor connection opening 13 and an actuating element 14. The connection unit 10 is mounted on a printed circuit board 15, with pins 16 of the connection unit 10 extending through the printed circuit board 15 and being soldered thereto. In the illustration in FIG. 1, electrical conductors 17 are introduced into some of the conductor connection openings 13 and held in the conductor connection openings 13 by the action of a spring force of a clamping spring (not shown). The clamping of the electrical conductors 17 in the relevant conductor connection opening 13 can be released by means of an actuation via the associated actuating element 14. The actuating elements 14 and the conductor connection openings 13 are arranged in two rows 18. The parallelly arranged connection elements 11 are arranged with a uniform grid dimension 19.

FIGS. 2 to 4 relate to a connection unit 20, 32 of a first, preferred embodiment of the invention.

In this embodiment, the connection unit 20 comprises sixteen parallelly arranged connection elements 21, 32 which are arranged in a common housing 22. In detail, the common housing 22 is designed as a housing 22 for printed circuit board mounting. The connection unit 20 is thus designed in the manner of printed circuit board clamps or a printed circuit board connector for printed circuit board mounting.

The connection elements 21, 32 are each designed as spring-loaded clamps 21 in the first embodiment. Correspondingly, each of the spring-loaded clamps 21 has a clamping spring 23, as can be seen from FIGS. 2 and 3, in which the connection unit 20 is shown partially without the housing 22. Due to the spring force thereof, the clamping spring 23 causes electrical conductors 26 to be held in a clamped manner in a corresponding conductor connection opening 24.

Each of the spring-loaded clamps 21 thus comprises a conductor connection opening 24 and, in addition, an actuating element 25. In this embodiment, the actuating elements 25 are designed as actuating pushbuttons 25 or pushers. The actuating pushbuttons 25 allow the clamping of the electrical conductor 26 held by the clamping spring 23 to be released when said pushbuttons are pressed in the direction of the relevant spring-loaded clamp 21. The actuating pushbutton 25 acts directly against the clamping spring 23 in order to tension the clamping spring 23 when said pushbutton is pressed in and to unclamp the electrical conductor 26 accommodated in the conductor connection opening 24. The restoring force of the clamping spring 23 resets the actuating pushbutton 25 after actuation. In addition, an electrical conductor 26 accommodated in the conductor connection opening 24 is clamped and contacted therein after actuation. In the case of spring-loaded clamps 21, the clamping of the electrical conductors 26 in the relevant conductor connection opening 24 already takes place by means of the insertion of the electrical conductors 26.

The electrical conductors 26 each lead an electrical potential. In this case, the electrical conductors 26 can comprise a single conducting wire or a plurality of conducting wires which are twisted together, for example.

The actuating elements 25 and the conductor connection openings 24 of the connection elements 21 are arranged in two rows 29 which are spaced apart from one another on one side 30 of the connection unit 20. For this purpose, the connection unit 20 comprises first and second spring-loaded clamps 21a, 21b which are arranged alternately adjacent to one another. The first and second spring-loaded clamps 21a, 21b are identical, with the second spring-loaded clamps 21b being arranged in the connection unit 20 in a manner rotated by 180° with respect to the first spring-loaded clamps 21a. The first and second spring-loaded clamps 21a, 21b are therefore antiparallelly arranged. Correspondingly, in the case of the first spring-loaded clamps 21a, the actuating elements 25 are arranged in a first row 29a and the conductor connection openings 24 are arranged in a second row 29b. In addition, in the case of the second spring-loaded clamps 21b, the actuating elements 25 are arranged in the second row 29b and the conductor connection openings 24 are arranged in the first row 29a.

The result is an arrangement of the first and second connection elements 21a, 21b in columns next to one another, with the actuating element 25 and the conductor connection opening 24 of a spring-loaded clamp 21 each forming a column. The actuating element 25 and the conductor connection opening 24 lie on an axis of the relevant spring-loaded clamp 21. The result is a matrix-like arrangement of the actuating elements 25 and the conductor connection openings 24 in the two rows 29 and in the spring-loaded clamps 21. The actuating element 25 and the conductor connection opening 24 of each spring-loaded clamp 21 are at the same distance from one another.

As can be seen in particular from FIG. 4, the adjacent spring-loaded clamps 21 are arranged with a uniform grid dimension 31. The grid dimension 31 defines a distance of an arrangement of the individual spring-loaded clamps 21 next to one another. It indicates the distance from a point of a spring-loaded clamp 21 to, in principle, the same point of an adjacent spring-loaded clamp 21. If the connection elements 21 are arranged next to one another without gaps, the grid dimension 31 corresponds to a width of the connection elements 21. In this embodiment, the connection elements 21 have a width that corresponds to the grid dimension 31.

In this embodiment, the grid dimension 31 is smaller than a collar diameter of a wire ferrule of a maximum usable connection cross section of the conductor connection opening 24. In detail, the spring-loaded clamps 21 are designed in such a way that the grid dimension 31 divided by a maximum collar diameter has a value of approximately 0.875. This means, for example, that a connection unit 21 comprising a conductor connection opening 24 having a maximum cross section of 4 mm² and a collar diameter of 5.4 mm results in a grid dimension of 4.8 mm rounded up (5.4×0.875=4.725). The collar diameter refers to a wire ferrule for use with the electrical conductor 26 having the appropriate cross section.

The connection unit 20 is mounted on a printed circuit board 27 with pins 28 extending through the printed circuit board 27 and soldered thereto as shown in FIG. 4. In this embodiment, the pins 28 are designed as contact pins which are connected to the clamping spring 23 of the relevant spring-loaded clamp 21 in order to contact the printed circuit board 27 and which bring about an electrical connection of the conductor connection openings 24 to the printed circuit board 27. The pins 28 are guided through the printed circuit board 27 in order to mount the connection unit 20 thereto, in particular by soldering.

In an alternative embodiment, the spring-loaded clamps 21 are arranged with a grid dimension 31 that is smaller than an outer diameter of an insulation of an electrical conductor 26 of a maximum usable connection cross section of the conductor connection openings 24. The adjacent arrangement of the first and second spring-loaded clamps 21a, 21b results in a distance between the conductor connection openings 24 of each row 29 that corresponds to twice the grid dimension 31, such that an insulation of the electrical conductors 26 protrudes beyond the relevant spring-loaded clamp 21.

In a second embodiment, which is shown in FIG. 5, the connection elements 21, 32 are designed as screw clamps 32. Otherwise, the connection unit 20 of the second embodiment corresponds to that of the first embodiment. The above statements in relation to the spring-loaded clamp 21 apply accordingly to the screw clamp 32.

In accordance with the design of the connection elements 21, 32 as screw clamps 32, the actuating elements 25, 33 are designed as actuating screws 33. In this embodiment, the electrical conductors 26 can be both clamped in the conductor connection openings 24 and released by the actuating screws 33, depending on a direction of rotation of the actuating screw 33.

Depending on the design of the screw clamps 32, deflection elements (not shown here) can be provided, which implement a screwing in of the actuating screws 33 in order to clamp electrical conductors 26 introduced parallel to the actuation screws 33 in the conductor connection openings 24 or to unclamp them. For example, the rotational movement of the actuating screws 33 can be deflected to clamping screws by an angle of 90°.

### LIST OF REFERENCE SIGNS

10 Connection unit (prior art)
11 Connection element (prior art)
12 Housing (prior art)
13 Conductor connection opening (prior art)
14 Actuating element (prior art)
15 Printed circuit board (prior art)
16 Pin, soldering pin (prior art)
17 Electrical conductor (prior art)
18 Row (prior art)
19 Grid dimension (prior art)
20 Connection unit
21 Connection element, spring-loaded clamp
21a First connection element, spring-loaded clamp
21b Second connection element, spring-loaded clamp

### 22 Housing

23 Clamping spring
24 Conductor connection opening
25 Actuating element, actuating pushbutton
26 Electrical conductor
27 Printed circuit board

### 28 Pin

### 29 Row

### 29a First row

### 29b Second row

### 30 Side

31 Grid dimension
32 Connection element, screw clamp
32a First connection element, screw clamp
32b Second connection element, screw clamp
33 Actuating element, actuating screw

1. A connection unit comprising:
a plurality of connection elements arranged next to one another, wherein each connection element has:
a conductor connection opening for accommodating an electrical conductor, and
an actuating element for clamping the electrical conductor in the conductor connection opening and/or releasing the electrical conductor,
wherein the actuating elements and the conductor connection openings are arranged on a common side of the connection unit, and
wherein the actuating elements and the conductor connection openings of the plurality of connection elements, respectively, are arranged in two rows which are spaced apart from one another, such that:
at least one first connection element has the respective actuating element is arranged in a first row and the respective conductor connection opening is arranged in a second row, and
at least one second connection element has the respective actuating element arranged in the second row and the respective conductor connection opening is arranged in the first row.

2. The connection unit according to claim 1, wherein:
the connection unit has a plurality of first and second connection elements, and
the first and second connection elements are arranged at least partially alternately adjacent to one another.

3. The connection unit according to claim 2, wherein the first and second connection elements are identical, the second connection elements being arranged in the connection unit in a manner rotated by 180° with respect to the first connection elements.

4. The connection unit according to claim 1, wherein the plurality of connection elements are arranged with a grid dimension which is smaller than a collar diameter of a wire ferrule of a maximum usable connection cross section of the conductor connection opening.

5. The connection unit according to claim 4, wherein the plurality of connection elements configured such that the grid dimension divided by a maximum collar diameter has a value of approximately 0.875.

6. The connection unit according to claim 4 wherein the plurality of connection elements are arranged with the grid dimension being smaller than an outer diameter of an insulation of an electrical conductor of a maximum usable connection cross section of the conductor connection openings.

7. The connection unit according to claim 1, wherein the connection unit further includes a common housing in which the plurality of connection elements are arranged.

8. The connection unit according to claim 7, wherein the common housing is configured for printed circuit board mounting.

9. The connection unit according to claim 1, wherein the plurality of connection elements are configured as spring-loaded clamps having a clamping spring, which keeps the electrical conductors clamped in the conductor connection openings with the spring force thereof, and the actuating elements configured to release the clamping of the electrical conductors via the clamping spring upon actuation.

10. The connection unit according to claim 9, wherein the actuating elements are actuating pushbuttons.

11. The connection unit according to claim 1, wherein:
the connection elements are screw clamps,
the actuating elements are actuating screws, and
the electrical conductors are both clamped in the conductor connection openings and released by the actuating screws.

12. The connection unit according to claim 1, wherein the respective conductor connection openings for accommodating electrical conductors have different maximum cross sections.

13. A connection block comprising:
a housing; and
a plurality of connection elements which are accommodated, and arranged next to one another, in the housing,
wherein each connection element has:
a conductor connection opening for accommodating an electrical conductor, and
an actuating element for clamping the electrical conductor in the conductor connection opening and/or releasing said conductor,
wherein the actuating elements and the conductor connection openings are arranged on a common side of the housing of the connection block, and
wherein the actuating elements and the conductor connection openings of the plurality of connection elements are arranged in two rows which are spaced apart from one another, such that:
at least one first connection element has the respective actuating element arranged in a first row and the respective conductor connection opening is arranged in a second row, and
at least one second connection element has the respective actuating element arranged in the second row and the respective conductor connection opening is arranged in the first row.
